(19) United States
(12) Patent Application Publication
(10) Pub. No.: US 2017/0058602 A1
(43) Pub. Date: Mar. 2, 2017

(54) MOUNTABLE LADDER CADDY

(71) Applicants: James Cureton, Morgantown, WV (US); Kimberly Cureton, Morgantown, WV (US)

(72) Inventors: James Cureton, Morgantown, WV (US); Kimberly Cureton, Morgantown, WV (US)

(21) Appl. No.: 14/834,349

(22) Filed: Aug. 24, 2015

(51) Int. Cl. E06C 7/14; A47B 23/00

(52) U.S. Cl. CPC E06C 7/14; A47B 23/001

(57) ABSTRACT

A mountable ladder caddy for securing to the top of a conventional step ladder in order to provide storage space for tools and other items to be used while on the ladder. The mountable ladder caddy includes a caddy base having top shelf with an open top and a plurality of dividers which is connected to a base assembly having a support base and a lower extension and which includes a hook attachment mechanism operative to enable the mountable ladder caddy to be selectively secured to the top of the ladder. The hook attachment mechanism includes a first spring loaded hook attached to the support base and operative to swing in a first direction and a second spring loaded hook attached to the lower extension and operative to swing in a second, opposing direction relative to the first direction.

### BACKGROUND OF THE INVENTION

Field of the Invention

This invention relates generally to ladder attachment device and, more particularly, to a mountable ladder caddy having a plurality of discrete trays and/or work areas.

Description of the Prior Art

The use and design of conventional step ladders for investigating, working on, or otherwise reaching items located in an elevated position is well known. Indeed, the use of conventional step ladders is very common not just for laborers such as electricians and handymen, but also for homeowners performing tasks around their dwelling. Despite the advantages conferred by such step ladders in reaching elevated areas, a problem which still exists is there is typically very little space for a user of a step ladder to store a plurality of tools for use while on the ladder. As a result, it is common for a user to have to repeatedly climb down their ladder to retrieve tools from a tool box or other location around the base of the ladder in order to perform tasks requiring the use of more than one tool. Thus, there remains a need for a mountable ladder caddy having a multi-section storage tray positioned to be easily accessible to one at the top of the ladder. It would be helpful if such a mountable ladder caddy included a hook attachment mechanism which enabled it to be selectively secured to the top portion of a ladder. It would be additionally desirable for such a mountable ladder caddy to have an angled design operative to not obstruct ladder steps when deployed.

The Applicant's invention described herein provides for a mountable ladder caddy adapted to allow a user to take a plurality of tools to the top of a ladder so as to be readily accessible without climbing down the ladder. The primary components in Applicant's mountable ladder caddy are a caddy base and a hook attachment mechanism. When in operation, the mountable ladder caddy enables more effective and efficient work at the top of a ladder by eliminating the need for a user to repeatedly climb down a ladder to retrieve different tools for use while on the ladder. As a result, many of the limitations imposed by prior art structures are removed.

### SUMMARY OF THE INVENTION

A mountable ladder caddy for securing to the top of a conventional step ladder in order to provide storage space for tools and other items to be used while on the ladder. The mountable ladder caddy includes a caddy base having top shelf with an open top and a plurality of dividers which is connected to a base assembly having a support base and a lower extension and which includes a hook attachment mechanism operative to enable the mountable ladder caddy to be selectively secured to the top of the ladder. The hook attachment mechanism includes a first spring loaded hook attached to the support base and operative to swing in a first direction and a second spring loaded hook attached to the lower extension and operative to swing in a second, opposing direction relative to the first direction. The mountable ladder caddy additionally includes a leveling feet attachment which can be attached to the top shelf so as to allow the mountable ladder caddy to be stood upright when not in place on a ladder.

It is an object of this invention to provide a mountable ladder caddy having a multi-section storage tray positioned to be easily accessible to one at the top of the ladder.

It is another object of this invention to provide a mountable ladder caddy which includes a hook attachment mechanism which enables it to be selectively secured to the top portion of a ladder.

It is yet another object of this invention to provide a mountable ladder caddy having an angled design operative to not obstruct ladder steps when deployed.

These and other objects will be apparent to one of skill in the art.

### BRIEF DESCRIPTION OF THE DRAWINGS

FIG. 1A is a side elevational view of a mountable ladder caddy built in accordance with the present invention with its hook attachment mechanism in a base position.

FIG. 1B is a rear elevational view of a mountable ladder caddy built in accordance with the present invention with its hook attachment mechanism in a base position.

FIG. 2 is a side elevational view of a mountable ladder caddy built in accordance with the present invention with its hook attachment mechanism in an attachment position.

FIG. 3 is a top plan view of a mountable ladder caddy built in accordance with the present invention.

FIG. 4 is a side elevational view of a mountable ladder caddy built in accordance with the present invention with its hook attachment mechanism in a base position and its leveling feet attachment deployed.

FIG. 5 is a top plan view of the leveling feet attachment of a mountable ladder caddy built in accordance with the present invention.

### DETAILED DESCRIPTION OF THE INVENTION

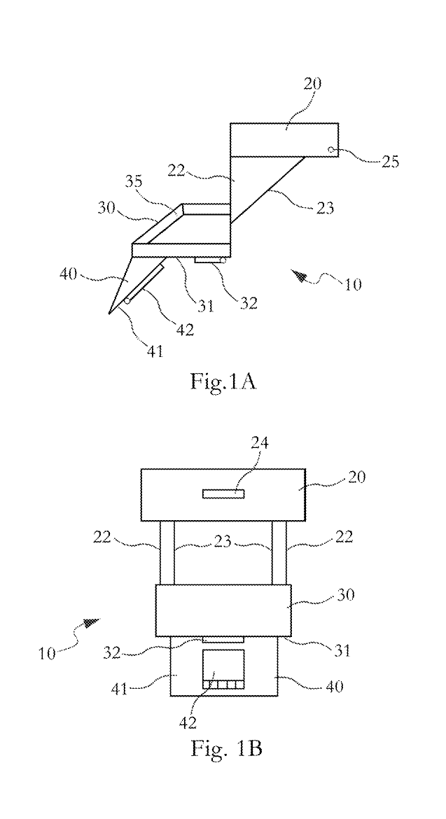

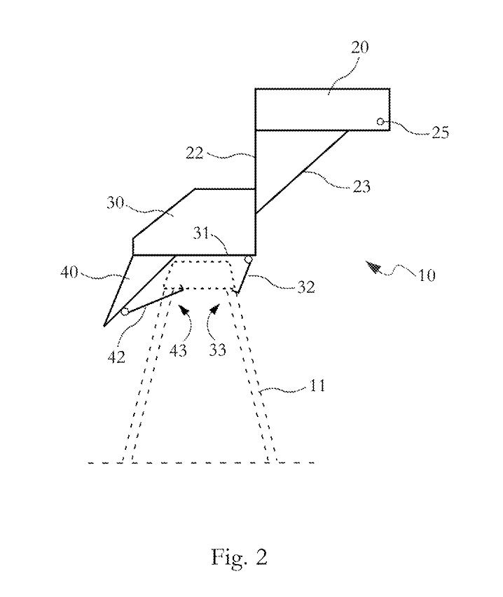

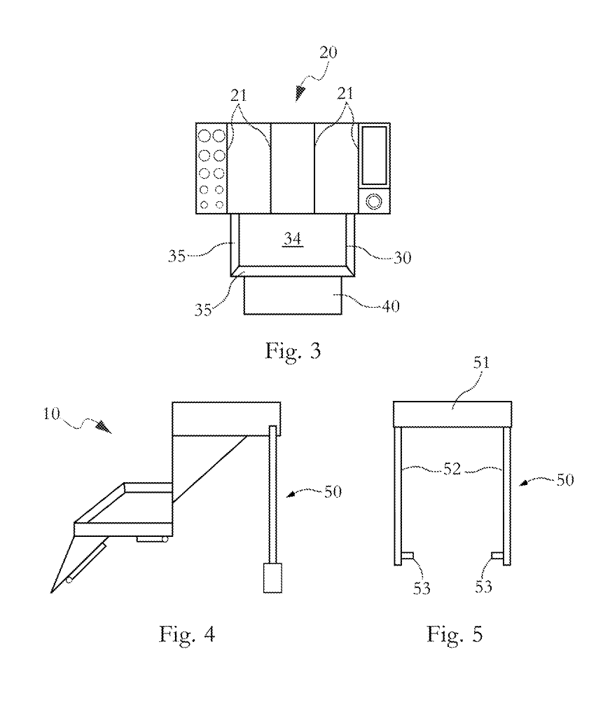

Referring now to the drawings and in particular FIGS. 1A, 1B, 2, and 3, a mountable ladder caddy 10 is shown as a caddy base having top shelf 20, a base assembly. The top shelf 20 defines a rigid receptacle having an open top and a plurality of dividers 21 so as to partition a plurality of discrete storage spaces. Offset underneath the top shelf 20 is the base assembly, to which it is connected through a first top rail 22 and a second top rail 23. The first top rail 22 and second top rail 23 defines a vertical and diagonal rail, respectively, which are positioned so as to work together to hold the top shelf 20 in place in an elevated position above the base assembly. Included on the rear surface of the top shelf 20 is a handling slot 24 to allow a user to manually grasp the mountable ladder caddy 10. It is contemplated that a user can grasp the top shelf 20 by inserting their fingers in the handling slot 24 with their thumb from the same hand on top of the top shelf 20.

The base assembly defines a support base 30 and a lower extension 40 and includes a hook attachment mechanism operative to enable the mountable ladder caddy 10 to be secured to the top of a conventional step ladder 11. The support base 30 includes a flat bottom 31 from which the lower extension 40 extends and to which a first hook 32 of the hook attachment mechanism is attached. The lower extension 40 includes an angled attachment surface 41 to which a second hook 42 of the hook attachment mechanism is attached. The first hook 32 and the second hook 42 each define spring loaded hooks, biased toward the respective surface to which they are attached. The first hook 32 and second hook 42 are oriented on the flat bottom 31 and attachment surface 41, respectively, such that they open and close in opposing directions, thereby configuring the hook attachment mechanism to provide securing pressure 33, 43 on a ladder 11 from opposing directions.

The top side of the support base 30 defines a planar support tray 34 which is surrounded by 1½″ side walls 35.

Referring now to FIGS. 1A, 1B, 2, 3, 4, and 5, the mountable ladder caddy 10 additionally includes a leveling feet attachment 50 which can be attached to attachment slots 25 in the top shelf 20 so as to allow the mountable ladder caddy 10 to be stood upright on a substantially flat ground/floor surface when not in place on a ladder 11. The leveling feet attachment defines a foot portion 51 connected to two leveling rails 52. Each leveling rail 52 includes an attachment rod 53 sized to be inserted into one of the attachment slots 25 when it is desired to connect the leveling feet attachment 50 to the top shelf 20. With the leveling feet attachment 50 in place, the mountable ladder caddy 10 is able to stand upright with the foot portion 51 and the bottom of the lower extension 40 contacting the surface.

It is appreciated that due to the round shape of the attachment slot 25 and attachment rod 53, the leveling feet attachment 50 can be extended from the top shelf at an angle (other than vertically from the flat bottom of the top shelf 20) if it is desired to stand the mountable ladder caddy 10 on a surface which is not substantially flat or level (i.e. on angled or stepped).

It is contemplated that the top shelf 20 may include a plurality of attachment slots 25 in its sides so as to increase the range of angles (relative to the flat bottom of the top shelf 20) at which the leveling feet attachment 50 may be placed.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A mountable ladder caddy, comprising:
a top shelf defining a rigid receptacle having an open top, a shelf bottom, two shelf sides, and a shelf backing;
a base assembly adapted to be secured to the top of a conventional step ladder, wherein said top shelf is mounted to said base assembly such that it is fixedly positioned above the base assembly; and
an attachment mechanism integral with said base assembly, wherein said attachment mechanism is operative to selectively provide securing pressure on a conventional step ladder on which the base assembly is placed from opposing directions.

2. The mountable ladder caddy of claim 1, wherein said top shelf includes at least one divider operative to partition a plurality of discrete storage spaces.

3. The mountable ladder caddy of claim 1, wherein said base assembly defines a support base and a lower extension and the attachment mechanism includes both a first attachment integral with the support base and a second attachment integral with the lower extension.

4. The mountable ladder caddy of claim 3, wherein said attachment mechanism defines a hook attachment mechanism such that the first attachment defines a first spring loaded hook and the second attachment defines a second spring loaded hook.

5. The mountable ladder caddy of claim 4, wherein said support base includes a flat bottom to which the first spring loaded hook is attached and the lower extension includes an angled bottom to which the second spring loaded hook is attached.

6. The mountable ladder caddy of claim 3, wherein said support base includes a flat bottom to which the first attachment is attached and the lower extension includes an angled bottom to which the second attachment is attached.

7. The mountable ladder caddy of claim 1, wherein said top shelf includes a handling slot in the shelf backing.

8. The mountable ladder caddy of claim 1, wherein the top shelf s horizontal positioning relative to the base assembly is offset such that the top shelf is relatively disposed above the base assembly at a diagonal angle.

9. The mountable ladder caddy of claim 8, wherein said top shelf is mounted to said base assembly through a first top rail and a second top rail.

10. The mountable ladder caddy of claim 9, wherein said first top rail defines a vertical rail and the second top rail defines a diagonal rail, thereby reinforcing the positioning of the top shelf to the above the base assembly.

11. The mountable ladder caddy of claim 1, wherein said attachment mechanism defines a hook attachment mechanism which includes a first spring loaded hook and a second spring loaded hook.

12. The mountable ladder caddy of claim 1, additionally comprising a leveling feet attachment which is selectively attachable to the top shelf, wherein when the leveling feet attachment is attached to the top shelf, the leveling feet attachment configures the mountable ladder caddy to be stood upright on a surface when not in place on a ladder.

13. The mountable ladder caddy of claim 12, wherein:
the shelf sides of said top shelf each include at least one attachment slot;
said leveling feet attachment includes a foot portion connected to two leveling rails, with each leveling rail includes at least one attachment rod; and
wherein said attachment slots are configured to receive the attachment rods so as to attach the leveling feet attachment to the top shelf.

14. The mountable ladder caddy of claim 12, wherein said attachment slots and attachment rods are configured such that the leveling feet attachment can be selectively positioned at one of a plurality of discrete angles.
